(19) United States
(12) Patent Application Publication
(10) Pub. No.: US 2019/0052160 A1
(43) Pub. Date: Feb. 14, 2019

(54) VIBRATION MOTOR

(71) Applicant: Nidec Seimitsu Corporation, Ueda-shi (JP)

(72) Inventor: Mitsuru OI, Ueda-shi (JP)

(21) Appl. No.: 16/048,416

(22) Filed: Jul. 30, 2018

(30) Foreign Application Priority Data
Aug. 9, 2017 (JP) 2017-154307

(51) Int. Cl. H02K 33/02; G08B 6/00

(52) U.S. Cl. CPC H02K 33/02; G08B 6/00

(57) ABSTRACT

A vibration motor includes a weight including a protrusion portion protruding from an end surface portion, the protrusion portion is positioned on at least one of an upper side and a lower side of a connecting portion when viewed in one direction, and the protrusion portion is in contact with a casing when a vibration body is displaced to a specific position.

### CROSS REFERENCE TO RELATED APPLICATIONS

This application claims the benefit of priority to Japanese Patent Application No. 2017-154307 filed on Aug. 9, 2017. The entire contents of this application are hereby incorporated herein by reference.

### BACKGROUND OF THE INVENTION

### 1. Field of the Invention

The present invention relates to a vibration motor.

### 2. Description of the Related Art

In the related art, various apparatuses such as a smartphone include a vibration motor.

The vibration motor includes a vibration body, four elastic members that support the vibration body, and a coil. The vibration body is supported by a base portion so as to be vibratable by the elastic members. If the vibration body excessively displaced, the elastic members may be damaged. Therefore, the vibration motor described above includes a movement restricting portion that restricts the movement by being in contact with the vibration body when a displacement amount of the vibration body becomes large. For example, a vibration motor is described in U.S. Pat. No. 8,269,379.

However, in the vibration motor described in U.S. Pat. No. 8,269,379, the movement restricting portion is formed to stand upward from a bottom surface portion included in the base portion. In the movement restricting portion having such a configuration, when the vibration body is in contact with the movement restricting portion, a strength of the movement restricting portion is not sufficient and the movement restricting portion may be deformed.

### SUMMARY OF THE INVENTION

In view of the above circumstances, preferred embodiments of the present invention provide vibration motors that reliably restrict a movement of a vibration body.

According to a preferred embodiment of the present invention, a vibration motor includes: a casing; an elastic member; and a vibration body that includes a weight and is supported by the elastic member with respect to the casing to be vibratable in one direction. The weight includes a first side wall portion and a second side wall portion facing the first side wall portion in a longitudinal direction orthogonal to the one direction. The elastic member includes a first fixing portion, a second fixing portion, and a connecting portion connecting the first fixing portion and the second fixing portion to each other. The first fixing portion is fixed to the first side wall portion. The second fixing portion is fixed to an inner wall surface facing the second side wall portion in the longitudinal direction in the casing. The connecting portion faces an end surface portion of the weight in the one direction on one side in the one direction. The weight includes a protrusion portion protruding from the end surface portion. The protrusion portion is positioned at least one of an upper side and a lower side of the connecting portion when viewed in the one direction. The protrusion portion is in contact with the casing in a case where the vibration body is displaced to a specific position.

According to another preferred embodiment of the present invention, a vibration motor includes a casing; an elastic member; and a vibration body that includes a weight and is supported by the elastic member with respect to the casing to be vibratable in one direction. The casing includes a base plate and a cover that covers the base plate from an upper side. The weight includes a first side wall portion and a second side wall portion facing the first side wall portion in a longitudinal direction orthogonal to the one direction. The elastic member includes a first fixing portion, a second fixing portion, and a connecting portion connecting the first fixing portion and the second fixing portion to each other. The first fixing portion is fixed to the first side wall portion. The second fixing portion is fixed to an inner wall surface facing the second side wall portion in the longitudinal direction in the casing. The connecting portion faces an end surface portion of the weight in the one direction on one side in the one direction. The cover includes a cover protrusion portion that protrudes from an inner wall surface of the cover facing the end surface portion in the one direction. The cover protrusion portion is positioned at least one of an upper side and a lower side of the connecting portion when viewed in the one direction. The weight is in contact with the cover protrusion portion in a case of being displaced to a specific position.

According to the vibration motors of preferred embodiments of the present invention, a movement restricting function to restrict a movement of the vibration body is satisfactorily maintained.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an entire perspective view of a vibration motor according to a preferred embodiment of the present invention.

FIG. 2 is an exploded perspective view of the vibration motor according to the preferred embodiment of the present invention.

FIG. 3 is a plan sectional view of the vibration motor according to the preferred embodiment of the present invention when viewed from an upper surface thereof.

FIG. 4 is a side sectional view of the vibration motor according to the preferred embodiment of the present invention.

FIG. 5 is a partially enlarged perspective view illustrating a main portion of a configuration around a protrusion member in the vibration motor.

FIG. 6 is a view of a weight when viewed from the other side in one direction in the vibration motor.

FIG. 7 is a partial plan view of a weight body portion when viewed from an upper surface side.

FIG. 8 is a partial plan view of the weight body portion when viewed from a lower surface side.

FIG. 9 is an exploded perspective view of a vibration motor according to a first modification example of a preferred embodiment of the present invention.

FIG. 10 is a partial side sectional view of the vibration motor according to the first modification example of the preferred embodiment of the present invention.

FIG. 11 is an exploded perspective view of a vibration motor according to a second modification example of a preferred embodiment of the present invention.

FIG. 12 is a partial side sectional view of the vibration motor according to the second modification example of the preferred embodiment of the present invention.

FIG. 13 is a schematic view illustrating a tactile device according to a preferred embodiment of the present invention.

### DETAILED DESCRIPTION OF THE PREFERRED EMBODIMENTS

Hereinafter, preferred embodiments of the present invention will be described with reference to the drawings. Moreover, in the following drawings, one direction (lateral direction), which is a direction in which a vibration body vibrates, is represented as an X direction. Specifically, one side in one direction is represented as an X1 direction and the other side in one direction is represented as an X2 direction. In addition, a longitudinal direction that is a direction orthogonal to one direction is represented as a Y direction. Specifically, one side in the longitudinal direction is represented as a Y1 direction and the other side in the longitudinal direction is represented as a Y2 direction. In addition, a vertical direction (height direction) that is a direction orthogonal to one direction and the longitudinal direction is represented as a Z direction. Specifically, an upper side is represented as a Z1 direction and a lower side is represented as a Z2 direction. However, the definition of the direction does not indicate a positional relationship and direction when it is incorporated in an actual apparatus.

### 1. Entire Configuration of Vibration Motor

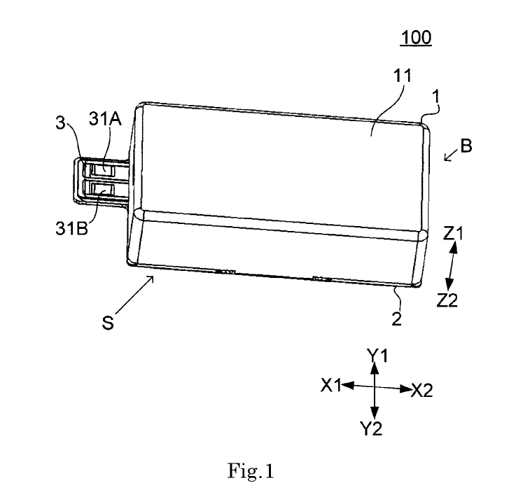

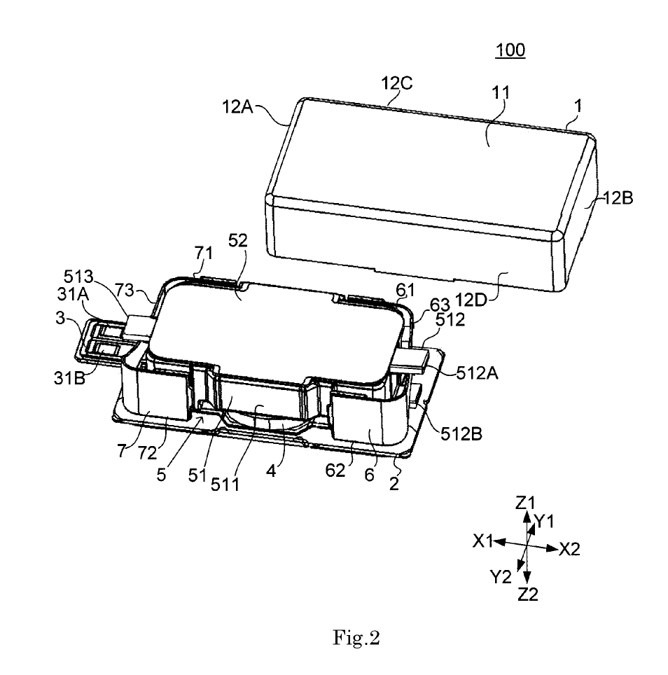

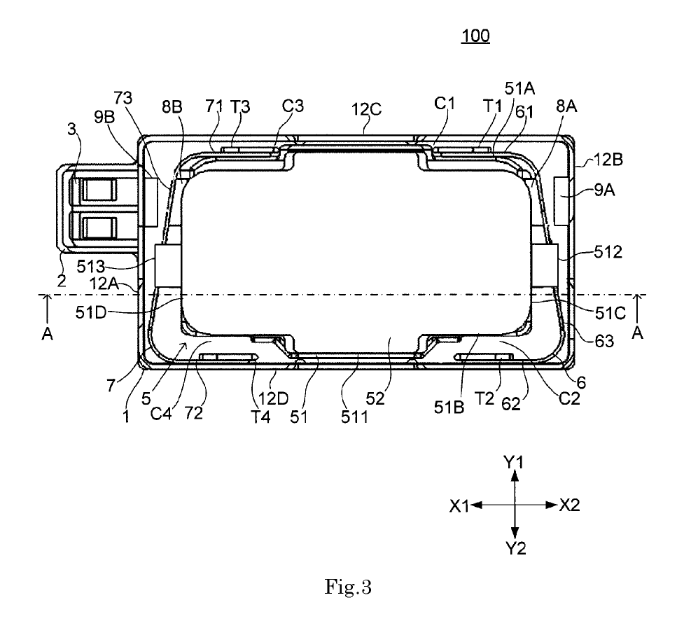

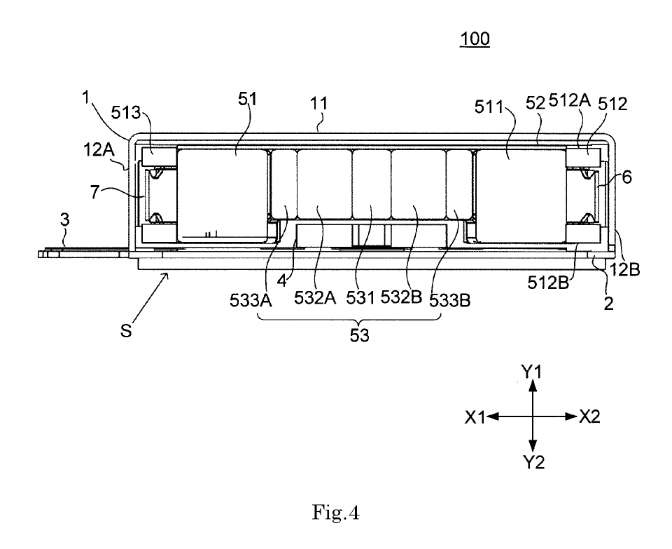

FIG. 1 is an entire perspective view of a vibration motor 100 according to a preferred embodiment of the invention. FIG. 2 is an exploded perspective view of the vibration motor 100. Moreover, FIG. 2 illustrates a state where a cover 1 is removed from a base plate 2. FIG. 3 is a plan sectional view of the vibration motor 100 when viewed from an upper surface thereof. FIG. 4 is a side sectional view of the vibration motor 100. Moreover, FIG. 4 is a sectional view of a state of being taken along a line A-A in FIG. 3.

The vibration motor 100 mainly includes a stationary portion S, a vibration body 5, an elastic member 6, and an elastic member 7. The stationary portion S includes the cover 1, the base plate 2, a board 3, and a coil 4. A casing B is configured with the cover 1 and the base plate 2.

The cover 1 includes a top surface portion 11 and each of side surface portions 12A to 12D and opens downward. Each of side surface portions 12A to 12D extends downward from each of four sides of the top surface portion 11. The side surface portions 12A and 12B face each other in one direction and the side surface portion 12A is positioned on one side in one direction from the side surface portion 12B. The side surface portions 12C and 12D face each other in the longitudinal direction and the side surface portion 12C is positioned on one side in the longitudinal direction from the side surface portion 12D. The cover 1 is formed of stainless steel (SUS).

The base plate 2 is a plate-like member extending in one direction and, for example, is formed of stainless steel (SUS). The cover 1 is mounted above the base plate 2. That is, the cover 1 covers the base plate 2 from an upper side. The board 3, the coil 4, the vibration body 5, the elastic member 6, and the elastic member 7 are accommodated in a space formed by the cover 1 and the base plate 2.

The board 3 is formed to extend in one direction and is configured as a flexible board or a rigid board. The board 3 is fixed on the base plate 2. An end portion of the board 3 on one side in one direction is disposed on an end portion of the base plate 2 on one side in one direction. Terminal portions 31A and 31B are formed the end portion of the board 3 on one side in one direction. A thickness direction of the board 3 is a direction along the vertical direction. In other words, the vertical direction is a direction along the thickness direction of the board 3.

The coil 4 is fixed on the board 3. The coil 4 is formed by winding a conductive wire around an axis in the vertical direction. The coil 4 is configured as a coreless coil. Each leading wire of the coil 4 is electrically connected to the terminal portions 31A and 31B. Therefore, a current can flow through the coil 4 by applying a voltage to the terminal portions 31A and 31B.

The vibration body 5 is disposed on an upper side from the coil 4 and is supported by the elastic members 6 and 7 with respect to the casing B so as to be vibratable in one direction. The vibration body 5 includes a weight 51, a back yoke 52, and a magnet portion 53.

The weight 51 includes a weight body portion 511, a protrusion member 512, and a protrusion member 513. The protrusion members 512 and 513 are separate members respectively from the weight body portion 511 and are fixed to the weight body portion 511. The weight body portion 511 and the protrusion members 512 and 513 can be simplified in structure and easy to mold by being separate members. For example, the weight body portion 511 and the protrusion members 512 and 513 are configured of the same material and, for example, are made of a tungsten alloy. Moreover, the protrusion members 512 and 513 will be described later in detail.

Particularly, as illustrated in FIG. 4, the weight body portion 511 accommodates the magnet portion 53 therein. The magnet portion 53 includes a center magnet 531, main magnets 532A and 532B, and side magnets 533A and 533B. The center magnet 531 is disposed so as to be sandwiched by the main magnets 532A and 532B from both sides in one direction. A portion formed of the center magnet 531 and the main magnets 532A and 532B is disposed so as to be sandwiched by the side magnets 533A and 533B from the both sides in one direction.

The back yoke 52 is disposed to cover upper surfaces of the weight body portion 511 and the magnet portion 53. The back yoke 52 is fixed to the weight body portion 511, for example, by welding. The back yoke 52 configures a magnetic circuit with the magnet portion 53 and improves power of the vibration motor 100.

The elastic member 6 is a leaf spring formed to extend in one direction and the longitudinal direction, one end is fixed to the weight 51, and the other end is fixed to the cover 1. The elastic member 7 is a leaf spring formed to extend in one direction and the longitudinal direction, one end is fixed to the weight 51, and the other end is fixed to the cover 1. Therefore, the vibration body 5 is supported by the elastic members 6 and 7 with respect to the cover 1. Moreover, the elastic members 6 and 7 will be described later in detail.

With such a configuration, in the vibration motor 100, the vibration body 5 reciprocates in one direction due to an interaction between a magnetic flux generated in the coil 4 and a magnetic flux by the magnet portion 53 by supplying a current to the coil 4.

### 2. Elastic Member

Next, a configuration of the elastic members 6 and 7 will be described in detail. Particularly, as illustrated in FIG. 3, the elastic member 6 includes a first fixing portion 61, a second fixing portion 62, and a connecting portion 63. The first fixing portion 61 has a flat plate shape extending in one direction. The second fixing portion 62 is positioned the other side in the longitudinal direction from the first fixing portion 61 and has a flat plate shape extending in one direction.

The connecting portion 63 connects the first fixing portion 61 and the second fixing portion 62. The connecting portion 63 is curved from the other side end in one direction to the other side in the longitudinal direction of the first fixing portion 61, linearly extends toward the other side in the longitudinal direction and the other side in one direction, and is curved to the other side end in one direction of the second fixing portion 62 when viewed from the upper surface. The connecting portion 63 faces an end surface portion 51C of the weight 51 in one direction on the other side in one direction. Moreover, the end surface portion 51C is a side surface formed from the weight body portion 511 and the protrusion member 512.

Here, the weight 51 includes a first side wall portion 51A and a second side wall portion 51B. Specifically, the first side wall portion 51A and the second side wall portion 51B are side walls of the weight body portion 511. The first side wall portion 51A extends in one direction, has a notch C1 on the other side in one direction, and has a notch C3 on one side in one direction. The second side wall portion 51B faces the first side wall portion 51A in the longitudinal direction, extends in one direction, has a notch C2 on the other side in one direction, and has a notch C4 on one side in one direction.

The first fixing portion 61 is fixed to the first side wall portion 51A in the notch C1. In addition, a reinforcing plate T1 is fixed to the first fixing portion 61. The first fixing portion 61 and the reinforcing plate T1 are fixed to the weight body portion 511, for example, by welding from an upper side and a lower side.

The second fixing portion 62 is fixed to an inner wall surface facing the second side wall portion 51B in the longitudinal direction on a notch C2 side in the side surface portion 12D of the cover 1. In addition, a reinforcing plate T2 is fixed to the second fixing portion 62. The second fixing portion 62 and the reinforcing plate T2 are fixed to the side surface portion 12D, for example, by welding from the other side in the longitudinal direction.

The first fixing portion 61 and the second fixing portion 62, which are liable to be subject to stress, can be respectively reinforced by the reinforcing plates T1 and T2.

In addition, the elastic member 7 includes a first fixing portion 71, a second fixing portion 72, and a connecting portion 73. The first fixing portion 71 has a flat plate shape extending in one direction. The second fixing portion 72 is positioned on the other side in the longitudinal direction from the first fixing portion 71 and has a flat plate shape extending in one direction.

The connecting portion 73 connects the first fixing portion 71 and the second fixing portion 72. The connecting portion 73 is curved from one side end in one direction to the other side in the longitudinal direction of the first fixing portion 71, linearly extends toward the other side in the longitudinal direction and one side in one direction, and is curved to one side end in one direction of the second fixing portion 72 when viewed from the upper surface. The connecting portion 73 faces an end surface portion 51D of the weight 51 in one direction on one side in one direction. Moreover, the end surface portion 51D is a side surface formed from the weight body portion 511 and the protrusion member 513.

The first fixing portion 71 is fixed to the first side wall portion 51A in the notch C3. In addition, a reinforcing plate T3 is fixed to the first fixing portion 71. The first fixing portion 71 and the reinforcing plate T3 are fixed to the weight body portion 511, for example, by welding from an upper side and a lower side.

The second fixing portion 72 is fixed to an inner wall surface facing the second side wall portion 51B in the longitudinal direction on a notch C4 side in the side surface portion 12D of the cover 1. In addition, a reinforcing plate T4 is fixed to the second fixing portion 72. The second fixing portion 72 and the reinforcing plate T4 are fixed to the side surface portion 12D, for example, by welding from the other side in the longitudinal direction.

The first fixing portion 71 and the second fixing portion 72, which are liable to be subject to stress, can be respectively reinforced by the reinforcing plates T3 and T4.

In addition, a damper portion 8A is disposed between the weight body portion 511 and the connecting portion 63. The damper portion 8A is fixed to the weight body portion 511. A damper portion 8B is disposed between the weight body portion 511 and the connecting portion 73. The damper portion 8B is fixed to the weight body portion 511. The damper portion 8A and the damper portion 8B reduce an attenuation time for which the vibration of the vibration body 5 attenuates when driving of the coil 4 is stopped.

In addition, a damper portion 9A is fixed to the inner wall surface of the side surface portion 12B and faces the connecting portion 63 in one direction. A damper portion 9B is fixed to the inner wall surface of the side surface portion 12A and faces the connecting portion 73 in one direction. In a normal vibration state of the vibration body 5, each of the elastic members 6 and 7 is not in contact with each of the damper portions 9A and 9B, but in a case where the vibration body 5 is displaced to a greater extent than normal state, each of the elastic members 6 and 7 is in contact with each of the damper portions 9A and 9B. Therefore, excessive displacement of the vibration body 5 can be suppressed. Moreover, each of the damper portions 9A and 9B may be in contact with each of the elastic members 6 and 7 when the elastic members 6 and 7 are in a natural state. In this case, the attenuation time of the vibration body 5 can be shortened by the damper portions 9A and 9B.

### 3. Protrusion Member (Blocker)

Next, the protrusion members 512 and 513 will be described in detail. The protrusion members 512 and 513 are movement restricting members (blockers) used to restrict the movement of the vibration body 5.

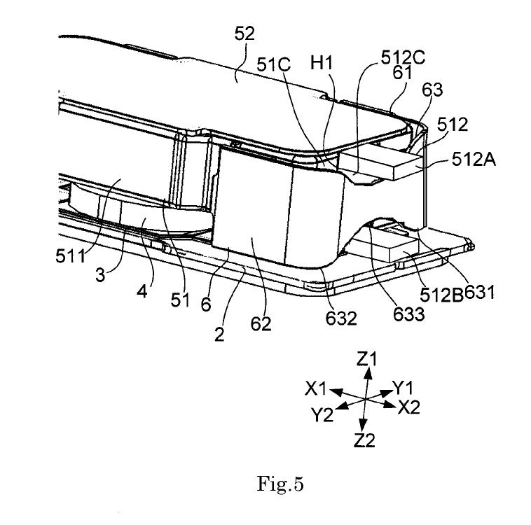

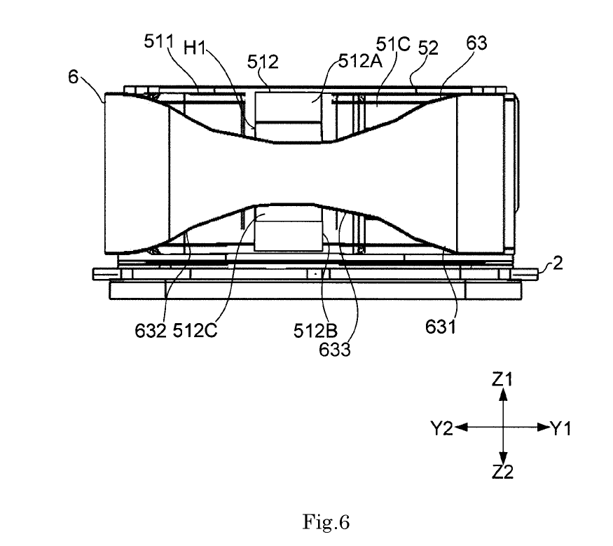

Here, a configuration of the protrusion member 512 as a representative will be described with reference to FIGS. 5 and 6. FIG. 5 is a partially enlarged perspective view illustrating a main portion of a configuration around the protrusion member 512 in the vibration motor 100. FIG. 6 is a view of the weight 51 when viewed from the other side in one direction in the vibration motor 100.

The protrusion member 512 includes a protrusion portion 512A, a protrusion portion 512B, and a connecting portion 512C. The protrusion portion 512A, the protrusion portion 512B, and the connecting portion 512C are formed as the same member. The protrusion portion 512A and the protrusion portion 512B have a substantially rectangular parallelepiped shape. The protrusion portion 512A and the protrusion portion 512B extend in one direction and face each other in the vertical direction. The protrusion portion 512A is disposed above the protrusion portion 512B. The connecting portion 512C connects a one end portion of the protrusion portion 512A in one direction and one end portion of the protrusion portion 512B in one direction in the vertical direction. That is, the protrusion member 512 is U-shaped in side view when viewed from the longitudinal direction.

The weight body portion 511 includes a groove portion H1 extending in the vertical direction on the other side in one direction. The groove portion H1 is formed to be recessed on one side in one direction. The protrusion member 512 is fitted into the groove portion H1. Specifically, the connecting portion 512C and an end portion on one side in one direction of each of the protrusion portions 512A and 512B are disposed in the groove portion H1. Moreover, a fixing method of the protrusion member 512 to the weight body portion 511 will be described later. Therefore, the protrusion portions 512A and 512B protrude from the end surface portion 51C to the other side in one direction. Moreover, tips of the protrusion portions 512A and 512B may be curved. In addition, the protrusion portions 512A and 512B may protrude to the other side in one direction and the vertical direction, or the other side in one direction and in the longitudinal direction. That is, the protrusion portions 512A and 512B may protrude in an oblique direction.

Here, the connecting portion 63 of the elastic member 6 includes a first wide-width portion 631, a second wide-width portion 632, and a narrow-width portion 633. The first wide-width portion 631 is connected to an end of the first fixing portion 61 on the other side in one direction. The second wide-width portion 632 is connected to an end of the second fixing portion 62 on the other side in one direction. The narrow-width portion 633 connects the first wide-width portion 631 and the second wide-width portion 632.

A width of the first wide-width portion 631 gradually decreases from a width of the first fixing portion 61 as it goes away from the first fixing portion 61. A width of the second wide-width portion 632 gradually decreases from a width of the second fixing portion 62 as it goes away from the second fixing portion 62. A width of the narrow-width portion 633 is smaller than the width of the first wide-width portion 631 and the width of the second wide-width portion 632.

Specifically, as illustrated in FIG. 6, the protrusion portion 512A is disposed above the narrow-width portion 633 and the protrusion portion 512B is disposed below the narrow-width portion 633 when viewed in one direction. That is, the protrusion portions 512A and 512B are respectively disposed above and below the connecting portion 63. As particularly illustrated in FIG. 4, the protrusion portions 512A and 512B respectively face the inner wall surface of the side surface portion 12B of the cover 1 in one direction.

In the normal vibration state of the vibration body 5, neither of the protrusion portions 512A and 512B are not in contact with the inner wall surface of the side surface portion 12B. When the vibration body 5 is displaced to a specific position exceeding a maximum displacement of the normal vibration state due to dropping of the vibration motor 100 or the like, the protrusion portions 512A and 512B are in contact with the inner wall surface of the side surface portion 12B. The specific position described above is a position in an effective movable range of the vibration body 5 in which the elastic member 6 is elastically deformed. Moreover, first, the elastic member 6 is in contact with the damper portion 9A and then the protrusion portions 512A and 512B are in contact with the inner wall surface of the side surface portion 12B.

Therefore, the movement of the vibration body 5 is restricted by the protrusion portions 512A and 512B and the vibration body 5 is excessively displaced and it is possible to prevent the elastic member 6 from being damaged due to excessive displacement of the vibration body 5. In addition, the protrusion portions 512A and 512B protrude in one direction and are not easily damaged even by contact with the cover 1. That is, it is possible to suppress that a function of the protrusion portions 512A and 512B is lost as blockers.

Moreover, since the protrusion member 513 has the same configuration and function as those of the protrusion member 512, details thereof will be omitted.

Particularly, the protrusion portion 512A positioned on the upper side of the connecting portion 63 when viewed in the one direction is in contact with the upper side of the side surface portion 12B. A strength of the upper side of the side surface portion 12B is high in the vicinity of the top surface portion 11 of the cover 1 and the upper side of the side surface portion 12B is hardly deformed even contact with the protrusion portion 512A.

In addition, the protrusion portions are positioned both sides of the upper side and the lower side of the connecting portion 63 when viewed in the one direction as the protrusion portions 512A and 512B. Therefore, the stress when the protrusion portion is in contact with the side surface portion 12B is dispersed and the deformation of the side surface portion 12B can be suppressed.

In addition, as particularly illustrated in FIG. 6, the protrusion portions 512A and 512B have a shape in which a length in the longitudinal direction is longer than a length in the vertical direction when viewed in the one direction. Therefore, a contact area with the side surface portion 12B in the protrusion portions 512A and 512B can be increased without increasing the length of the protrusion portion in the vertical direction. Therefore, the stress due to the contact can be dispersed and deformation of the protrusion portions 512A and 512B, and the side surface portion 12B can be suppressed while suppressing an increase in a size of the vibration motor 100 in the vertical direction.

In addition, as particularly illustrated in FIG. 6, the protrusion portions 512A and 512B are positioned on the upper side and the lower side of the narrow-width portion 633 when viewed in the one direction. If the width of the connecting portion 63 is constant, the thickness of the weight in the vertical direction is thick in order to provide the protrusion portion, but this can be avoided. In addition, portions which do not interfere with the protrusion portions 512A and 512B in the connecting portion 63 can be the first wide-width portion 631 and the second wide-width portion 632. The stress in the elastic member 6 can be dispersed and damage of the first fixing portion 61 and the second fixing portion 62 to which the stress is easily applied can be suppressed by providing the first wide-width portion 631 and the second wide-width portion 632.

In addition, it is preferable that the protrusion portions 512A and 512B are made of a tungsten alloy and the cover 1 is made of stainless steel (SUS). Therefore, as a material of the protrusion portion, the tungsten alloy suitable for a material of the weight 51 can be used, the strength of the protrusion portion is high with respect to the side surface portion 12B made of stainless steel, and damage of the protrusion portion due to contact is suppressed.

### 4. Fixing Method of Protrusion Portion

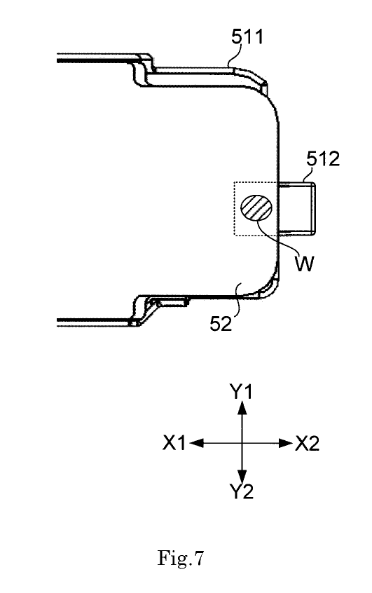

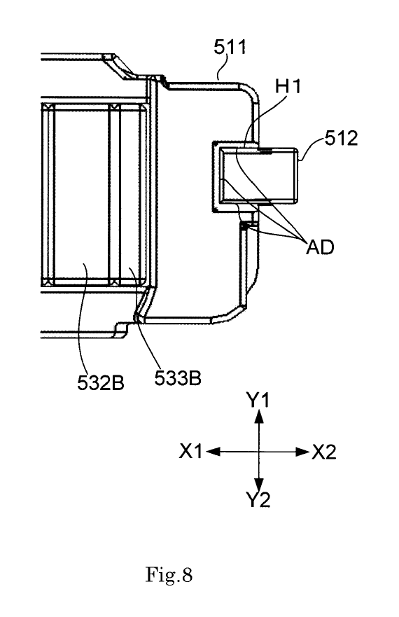

Here, an example of a fixing method of the protrusion members 512 and 513 to the weight body portion 511 will be described with reference to FIGS. 7 and 8. FIG. 7 is a partial plan view of the weight body portion 511 when viewed from the upper surface side. In a state where the magnet portion 53 and the back yoke 52 are fixed to the weight body portion 511, the protrusion member 512 is fitted into the groove portion H1. In this case, the upper surface of the protrusion member 512 can be in contact with the lower surface of the back yoke 52. Therefore, the protrusion member 512 can be positioned. In a state of being positioned, as illustrated in FIG. 7, a welding portion W is formed by welding from an upper surface side of the back yoke 52, so that the upper surface of the protrusion member 512 is fixed to the back yoke 52.

FIG. 8 is a partial plan view of the weight body portion 511 when viewed from the lower surface side. In the above description, the protrusion member 512 is fixed to the back yoke 52 and then an adhesive is poured from the lower side to an adhesion surface AD that is a surface which is in contact with the groove portion H1 into which the protrusion member 512 is fitted. The adhesive is cured so that the protrusion member 512 is fixed to the groove portion H1.

### 5. First Modification Example of Vibration Motor

Next, a modification example of preferred embodiments of the present invention will be described below. In the description of the modification example, basically, the description of the same configuration as that of the preferred embodiments of the present invention described above will be omitted and differences of the configuration will be mainly described.

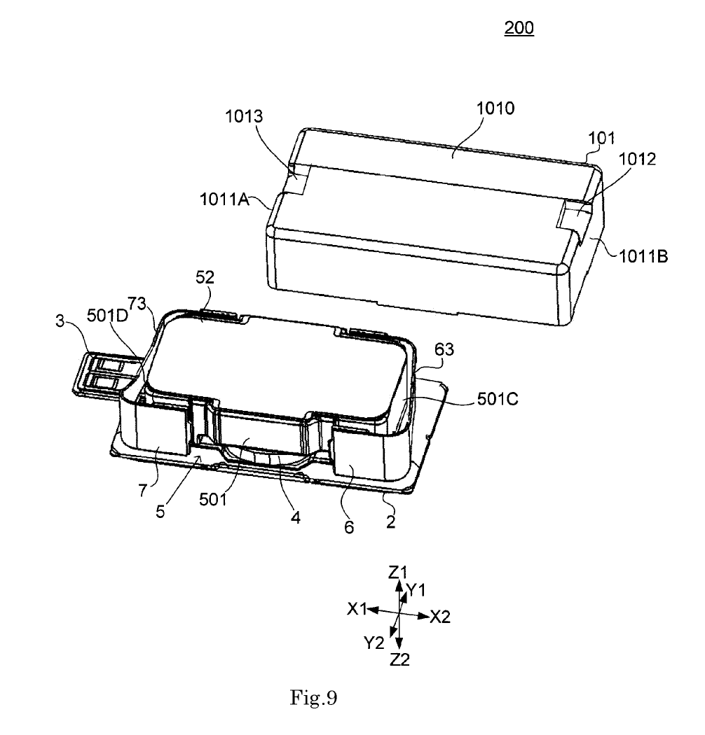

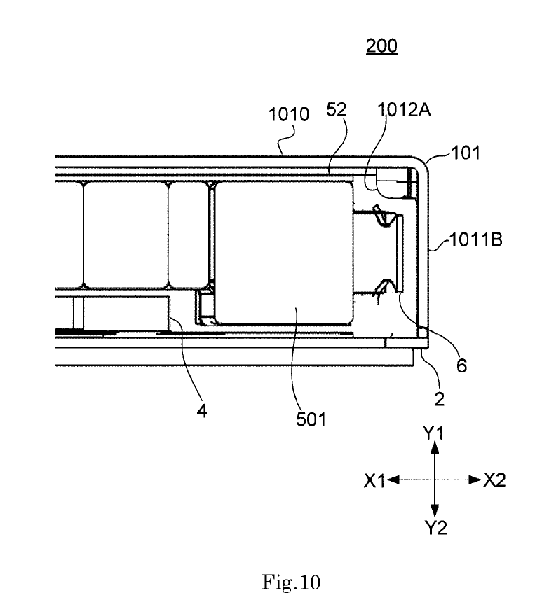

First, a vibration motor according to a first modification example will be described. FIG. 9 is an exploded perspective view of a vibration motor 200 according to a first modification example. Moreover, FIG. 9 is a view corresponding to FIG. 2 of the embodiment described above. In addition, FIG. 10 is a partial side sectional view of the vibration motor 200 according to the first modification example.

In the vibration motor 200, a vibration body 5 includes a weight 501. Different from the vibration motor 100 described above, the weight 501 does not include a protrusion portion. That is, the weight 501 corresponds to being formed only of a weight body portion. An end surface portion 501C of the weight 501 on the other side in one direction does not have a shape protruding in one direction but is flat. An end surface portion 501D of the weight 501 on one side in one direction does not have a shape protruding in one direction but is flat.

A connecting portion 63 of an elastic member 6 faces the end surface portion 501C in one direction. A connecting portion 73 of an elastic member 7 faces the end surface portion 501D in one direction.

In addition, the vibration motor 200 includes a cover 101. The cover 101 includes a top surface portion 1010, a side surface portion 1011A, and a side surface portion 1011B. The side surface portion 1011A and the side surface portion 1011B face each other in one direction. A recess portion 1012 is formed on an upper surface of the cover 101 on the other side in one direction. The recess portion 1012 is recessed downward from the top surface portion 1010 and is recessed on one side in one direction from the side surface portion 1011B. A recess portion 1013 is formed on the upper surface of the cover 101 on one side in one direction. The recess portion 1013 is recessed downward from the top surface portion 1010 and is recessed on the other side in one direction from the side surface portion 1011A.

As illustrated in FIG. 10, a cover protrusion portion 1012A is formed by the recess portion 1012 on an inside of the cover 101. The cover protrusion portion 1012A protrudes on one side in one direction and a downward direction. The cover protrusion portion 1012A protrudes from an inner wall surface of the side surface portion 1011B. The cover protrusion portion 1012A is disposed on an upper side of the connecting portion 63 when viewed in the one direction. Moreover, the cover protrusion portion may protrude only on one side in one direction without protruding in the downward direction.

In a normal vibration state of the vibration body 5, the end surface portion 501C of the weight 501 is not in contact with the cover protrusion portion 1012A. When the vibration body 5 is displaced to a specific position exceeding a maximum displacement of the normal vibration state due to dropping of the vibration motor 200 or the like, the end surface portion 501C is in contact with the cover protrusion portion 1012A. The specific position described above is a position in an effective movable range of the vibration body 5 similar to the above description.

Therefore, the movement of the vibration body 5 is restricted by the cover protrusion portion 1012A, and it is possible to prevent the elastic member 6 from being damaged due to excessive displacement of the vibration body 5. In addition, the cover protrusion portion 1012A protrudes in one direction and is not easily damaged even by contact with the weight 501. That is, it is possible to suppress that a function of the cover protrusion portion 1012A is lost as a blocker.

Moreover, similarly, a cover protrusion portion (not illustrated) is formed by the recess portion 1013 on an inside of the cover 101 and the function by the cover protrusion portion is similar to that of the cover protrusion portion 1012A.

In addition, the cover protrusion portion 1012A and the like are positioned on the upper sides of the connecting portions 63 and 73. Since a strength of the upper side positioned in the top surface portion 1010 is high, the cover 101 is hardly deformed even if the weight 501 is in contact with the cover protrusion portion 1012A or the like.

In addition, the cover 101 is formed by a narrowing process and the recess portion 1012 and the recess portion 1013 are formed in this processing. That is, the cover protrusion portion 1012A or the like is formed as the same member as a portion other than the cover protrusion portion in the cover 101. Therefore, a step of connecting the cover protrusion portion by welding or the like can be omitted and the cover can be efficiently manufactured.

Moreover, the cover 101 may be formed by fixing the cover protrusion portion of a separate member to an inside of the cover body portion having no recess portion like the cover 1 illustrated in FIG. 1. In this case, the cover protrusion portion is fixed to the cover body portion by welding or adhesion. Therefore, each of the cover body portion and the cover protrusion portion can be formed in a simple shape and can be easily molded.

In addition, the cover protrusion portion 1012A or the like has a shape in which a length in the longitudinal direction is longer than a length in the vertical direction when viewed in the one direction. Therefore, a contact area with the weight 501 in the cover protrusion portion can be increased without increasing the length of the cover protrusion portion in the vertical direction. Therefore, the stress due to the contact can be dispersed and deformation of the cover protrusion portion can be suppressed while suppressing an increase in a size of the vibration motor 200 in the vertical direction.

Moreover, a cover protrusion portion protruding in one direction on the inside of the cover 101 may be formed on a lower side of each of the side surface portions 1011B and 1011A of the cover 101. In this case, the cover protrusion portion is disposed on the lower sides of the connecting portions 63 and 73 when viewed in the one direction. Moreover, the cover protrusion portion may be provided together with the cover protrusion portion 1012A on the upper side described above or may be formed without providing the cover protrusion portion on the upper side.

### 6. Second Modification Example of Vibration Motor

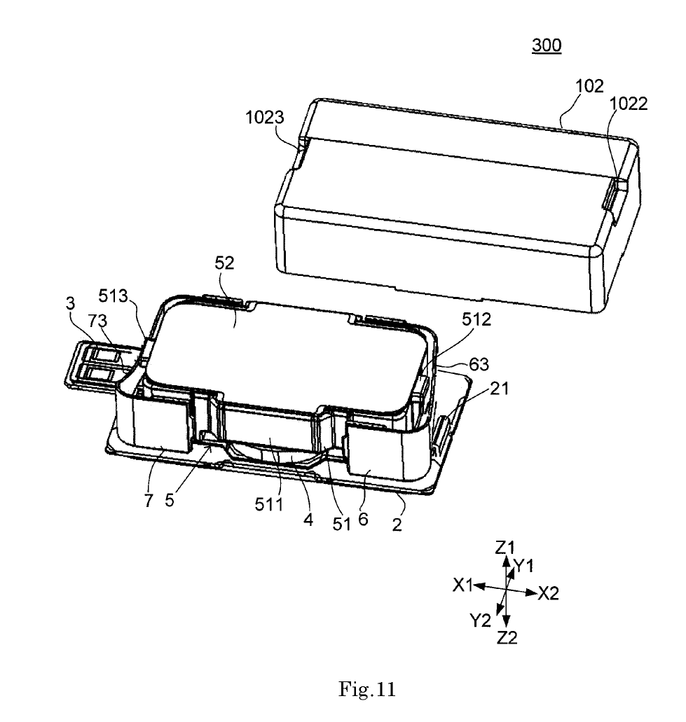

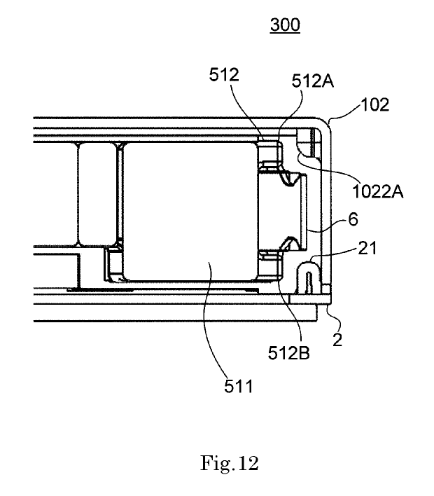

Next, a vibration motor according to a second modification example of a preferred embodiment of the present invention will be described. FIG. 11 is an exploded perspective view of a vibration motor 300 according to the second modification example. Moreover, FIG. 11 is a view corresponding to FIG. 2 of the preferred embodiments of the present invention described above. In addition, FIG. 12 is a partial side sectional view of the vibration motor 300 according to the second modification example.

In the vibration motor 300, a vibration body 5 is similar to that of the embodiment illustrated in FIG. 2 described above. That is, the vibration body 5 includes a weight 51 and the weight 51 includes a weight body portion 511 and protrusion members 512 and 513. However, protrusion lengths of protrusion portions (512A, 512B, and the like) included in the protrusion members 512 and 513 are shorter than those of the embodiment described above.

In addition, in the vibration motor 300, in a cover 102, recess portions 1022 and 1023 are formed similarly to the cover 101 (FIG. 9) according to the first modification example described above. As illustrated in FIG. 12, a cover protrusion portion 1022A is formed on an inside of the cover 102 by the recess portion 1022. The cover protrusion portion 1022A faces the protrusion portion 512A in one direction.

In addition, the base plate 2 includes a base plate protrusion portion 21 formed to protrude from a base portion of the base plate 2 to an upper side. The base plate protrusion portion 21 faces the protrusion portion 512B in one direction.

According to such a configuration, in a case where the vibration body 5 is displaced to a specific position, the protrusion portion 512A is in contact with the cover protrusion portion 1022A and the protrusion portion 512B protrudes to the base plate protrusion portion 21. Therefore, the movement of the vibration body 5 is restricted and break of the elastic member 6 is avoided.

Moreover, functions of the cover protrusion portion formed by the protrusion member 513 and the recess portion 1023, and the base plate protrusion portion (not illustrated) formed at a position facing the base plate protrusion portion 21 in one direction are similar to the above description.

Particularly, the cover protrusion portion 1022A is disposed at a position which is in contact with the protrusion portion 512A positioned on the upper side. Therefore, the cover protrusion portion 1022A is disposed on the upper side in the cover 102 and the cover 102 has high strength on the upper side, so that even when the protrusion portion 512A is in contact with the cover protrusion portion 1022A, the cover 102 is hardly deformed.

In addition, the lower side of the cover 102 has low strength, so that the protrusion portion 512B on the lower side is in contact with the base plate protrusion portion 21 and is not in contact with the cover 102. However, the cover protrusion portion facing the protrusion portion 512B in one direction may be formed in the cover 102.

### 7. Tactile Device

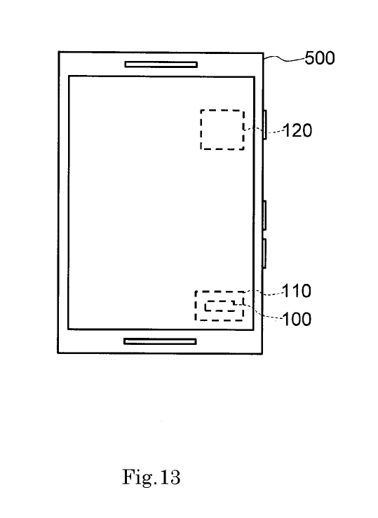

As illustrated in FIG. 13, for example, the vibration motor 100 can be mounted on a tactile device 500. Moreover, the vibration motors 200 and 300 according to the modification examples described above can be mounted on the tactile device 500. The tactile device 500 gives a tactile stimulus to a person operating the tactile device 500 by vibration of the vibration motor 100. As the tactile device 500, for example, a mobile phone including a smartphone, a tablet, a game machine, and a wearable terminal can be adopted.

The tactile device 500 of the embodiment includes the vibration motor 100, a board 110 on which the vibration motor 100 is mounted, and a control portion 120. The vibration motor 100 is electrically and mechanically connected to the board 110. The control portion 120 outputs a driving current to the vibration motor 100 via the board 110. The vibration motor 100 vibrates according to a driving signal from the control portion 120. The tactile device 500 vibrates so as to give the tactile stimulus to a person operating the tactile device 500 by the vibration of the vibration motor 100.

### 8. Operational Effects of Embodiment

Exemplary operational effects by the vibration motor of the preferred embodiments of the present invention described above are as follows. Here, as an example, the description is given focusing on the configuration on the elastic member 6 side and definitions one side and the other side in one direction are reversed from the drawings for the sake of convenience.

The vibration motor (100) of the embodiment includes the casing (B), the elastic member (6), and the weight (51), and includes the vibration body (5) supported by the elastic member with respect to the casing so as to be vibratable in one direction. The weight includes the first side wall portion (51A) and the second side wall portion (51B) facing the first side wall portion in the longitudinal direction orthogonal to one direction. The elastic member includes the first fixing portion (61), the second fixing portion (62), and the connecting portion (63) connecting the first fixing portion and the second fixing portion. The first fixing portion is fixed to the first side wall portion. The second fixing portion is fixed to the inner wall surface facing the second side wall portion in the longitudinal direction of the casing. The connecting portion faces the end surface portion (51C) of the weight in one direction on one side in one direction. The weight includes the protrusion portions (512A and 512B) protruding from the end surface portion. The protrusion portion is positioned at least one of the upper side and the lower side of the connecting portion when viewed in the one direction. The protrusion portion is in contact with the casing in a case where the vibration body is displaced to the specific position.

According to such a configuration, the protrusion portion has a function of restricting the movement of the vibration body and suppresses damage of the elastic member due to excessive displacement of the vibration body. When the protrusion portion is in contact with the casing, the protrusion portion is supported by the weight body portion on a side opposite to the casing. That is, at the time of contact, the protrusion portion is sandwiched between the casing and the weight body portion. Therefore, deformation of the protrusion portion can be suppressed. That is, it is possible to favorably maintain the movement restricting function of performing the movement restriction of the vibration body.

In addition, the casing (B) includes the base plate (2) and the cover (1) that covers the base plate from the upper side, and the protrusion portions (512A and 512B) are positioned at least on the upper side of the connecting portion (63) when viewed in the one direction. Therefore, the protrusion portion on the upper side is in contact with the upper side of the cover and the strength of the upper side of the cover is high, so that the cover is hardly deformed.

In addition, the protrusion portions (512A and 512B) are positioned on the both sides of the upper side and the lower side of the connecting portion (63) when viewed in the one direction. Therefore, the stress when the protrusion portion is in contact with the casing is dispersed and the deformation of the casing can be suppressed compared to a configuration in which the protrusion portion is positioned only one of the upper side or the lower side of the connecting portion.

In addition, the protrusion portions (512A and 512B) have a shape in which the length in the longitudinal direction is longer than the length in the vertical direction when viewed in the one direction. Therefore, the contact area with the casing in the protrusion portion can be increased without increasing the height of the protrusion portion in the vertical direction. Therefore, the stress due to the contact can be dispersed and deformation of the protrusion portion and the casing can be suppressed while suppressing an increase in the size of the vibration motor in the vertical direction.

In addition, the weight (51) includes the weight body portion (511) and the protrusion member (512) having the protrusion portions (512A and 512B) as the separate members from the weight body portion. Therefore, the configuration of each of the weight body portion and the protrusion portion can be easily simplified and it is easy to mold each of them.

In addition, the vibration body (5) includes the back yoke (52) which is fixed to the top surface of the weight body portion (511), the weight body portion includes the groove portion (H1) which is recessed at the end surface portion on the other side in one direction, the protrusion member (512) is in contact with the back yoke while fitting into the groove portion. Therefore, when the protrusion member is fixed to the weight body portion, positioning of the protrusion member is easy.

In addition, the connecting portion (63) includes the first wide-width portion (631) which is connected to the first fixing portion (61), the second wide-width portion (632) which is connected to the second fixing portion (62), and the narrow-width portion (633) which connects the first wide-width portion and the second wide-width portion. The width of the first wide-width portion gradually decreases from the width of the first fixing portion as it goes away from the first fixing portion, and the width of the second wide-width portion gradually decreases from the width of the second fixing portion as it goes away from the second fixing portion. The width of the narrow-width portion is smaller than the width of the first wide-width portion and the width of the second wide-width portion. The protrusion portions (512A and 512B) are positioned at least one of the upper side and the lower side of the narrow-width portion when viewed in the one direction.

Therefore, it is possible to avoid the thickness of the weight in the vertical direction becoming thick in order to provide the protrusion portion avoiding the connecting portion. In addition, the portions which do not interfere with the protrusion portion in the connecting portion can be the first wide-width portion and the second wide-width portion. Therefore, the stress in the elastic member can be dispersed and damage of the fixing portion to which the stress is easily applied can be suppressed.

In addition, the casing (B) includes the base plate (2) and the cover (102) that covers the base plate from the upper side, and the cover includes the cover protrusion portion (1022A) that protrudes from the inner wall surface of the cover facing the end surface portion in the one direction to face the protrusion portion (512A) in one direction. Therefore, the protrusion portion is in contact with the cover protrusion portion and the movement of the vibration body can be suppressed in a case where the vibration body is displaced to the specific position.

In addition, the protrusion portion (512A) positioned on the upper side from the connecting portion (63) when viewed in the one direction is in contact with the cover protrusion portion (1022A). Therefore, the upper side of the cover in which the cover protrusion portion is disposed has high strength, so that even when the protrusion portion is in contact with the cover protrusion portion, deformation of the cover can be suppressed.

In addition, the casing (B) includes the base plate (2) and the cover (102) that covers the base plate from the upper side, the base plate (2) includes the base plate protrusion portion (21) protruding to the upper side, and the protrusion portion (512B) that is positioned on the lower side from the connecting portion (63) when viewed in the one direction is in contact with the base plate protrusion portion. Therefore, the lower side of the cover has low strength, so that the protrusion portion is in contact with the base plate protrusion portion and cannot be in contact with the cover.

In addition, the protrusion portions (512A and 512B) include at least tungsten, and the portion with which the protrusion portion is in contact in the casing (B) includes stainless steel (SUS). Therefore, as the material of the protrusion portion, tungsten suitable for the material of the weight can be used, the strength of the protrusion portion including at least tungsten is high with respect to the casing having SUS, and damage of the protrusion portion due to contact is suppressed.

In addition, the vibration motor (200) of the embodiment includes the casing (B), the elastic member (6), and the weight (501), and includes the vibration body (5) which is supported by the elastic member so as to be vibratable in one direction with respect to the casing. The casing includes the base plate (2) and the cover (101) that covers the base plate from the upper side. The weight includes the first side wall portion and the second side wall portion that faces the first side wall portion in the longitudinal direction orthogonal to one direction. The elastic member includes the first fixing portion (61), the second fixing portion (62), and the connecting portion (63) that connects the first fixing portion and the second fixing portion. The first fixing portion is fixed to the first side wall portion and the second fixing portion is fixed to the inner wall surface facing the second side wall portion in the longitudinal direction in the casing. The connecting portion faces the end surface portion of the weight in one direction on one side in one direction. The cover includes the cover protrusion portion (1012A) protruding from the inner wall surface of the cover facing the end surface portion in one direction. The cover protrusion portion (1012A) is positioned at least one of the upper side and the lower side of the connecting portion when viewed in the one direction. The weight is in contact with the cover protrusion portion in a case of being displaced to the specific position.

According to such a configuration, the cover protrusion portion has a function of restricting the movement of the vibration body and suppresses damage of the elastic member due to excessive displacement of the vibration body. When the cover protrusion portion is in contact with the weight, the cover protrusion portion is supported by the cover body portion on a side opposite to the weight. Therefore, deformation of the cover protrusion portion can be suppressed. That is, it is possible to favorably maintain the movement restricting function of performing the movement restriction of the vibration body.

The cover protrusion portion (1012A) is positioned at least on the upper side of the connecting portion (63) when viewed in the one direction. Therefore, the upper side of the cover in which the cover protrusion portion is disposed has high strength, so that even when the weight is in contact with the cover protrusion portion, deformation of the cover can be suppressed.

In addition, the cover protrusion portion (1012A) is formed as the same member as a portion other than the cover protrusion portion in the cover (101). Therefore, since the cover protrusion portion can be manufactured when the cover is manufactured by the narrowing process, a step of connecting the cover protrusion portion by welding or the like can be omitted and the cover can be efficiently manufactured.

In addition, the cover includes the cover body portion and the cover protrusion portion of the separate member from the cover body portion. Therefore, each of the cover body portion and the cover protrusion portion can be formed in a simple shape and can be easily manufactured.

In addition, the cover protrusion portion (1012A) has a shape in which the length in the longitudinal direction is longer than the length in the vertical direction when viewed in the one direction. Therefore, the contact area with the weight in the cover protrusion portion can be increased without increasing the height of the cover protrusion portion in the vertical direction. Therefore, the stress due to the contact can be dispersed and deformation of the cover protrusion portion can be suppressed while suppressing an increase in the size of the vibration motor in the vertical direction.

In addition, the tactile device (500) of the embodiment includes the vibration motor of any one of the above configurations.

### 9. Others

Above, although the embodiments of the invention are described, various modifications can be made to the embodiments as long as they are within the scope of the gist of the invention.

The invention can be applied to the vibration motor provided in various devices.

Features of the above-described preferred embodiments and the modifications thereof may be combined appropriately as long as no conflict arises. While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibration motor comprising:
a casing;
an elastic member; and
a vibration body that includes a weight and is supported by the elastic member with respect to the casing to be vibratable in one direction; wherein
the weight includes a first side wall portion and a second side wall portion facing the first side wall portion in a longitudinal direction that is orthogonal or substantially orthogonal to the one direction;
the elastic member includes a first fixing portion, a second fixing portion, and a connecting portion connecting the first fixing portion and the second fixing portion to each other;
the first fixing portion is fixed to the first side wall portion;
the second fixing portion is fixed to an inner wall surface facing the second side wall portion in the longitudinal direction in the casing;
the connecting portion faces an end surface portion of the weight in the one direction on one side in the one direction;
the weight includes a protrusion portion protruding from the end surface portion;
the protrusion portion is positioned in at least one of an upper side and a lower side of the connecting portion when viewed in the one direction; and
the protrusion portion is in contact with the casing in a case when the vibration body is displaced to a specific position.

2. The vibration motor according to claim 1, wherein
the casing includes a base plate and a cover that covers the base plate from an upper side; and
the protrusion portion is positioned at least on the upper side of the connecting portion when viewed in the one direction.

3. The vibration motor according to claim 1, wherein the protrusion portion includes an upper protrusion portion on the upper side and a lower protrusion portion the lower side of the connecting portion when viewed in the one direction.

4. The vibration motor according to claim 1, wherein the protrusion portion has a length in the longitudinal direction longer than a length in a vertical direction when viewed in the one direction.

5. The vibration motor according to claim 1, wherein the weight includes a weight body portion and a protrusion member including the protrusion portion that is separate from the weight body portion.

6. The vibration motor according to claim 5, wherein
the vibration body includes a back yoke that is fixed to a top surface of the weight body portion;
the weight body portion includes a groove portion that is recessed toward the other side in the one direction at the end surface portion; and
the protrusion member is in contact with the back yoke while being fitted into the groove portion.

7. The vibration motor according to claim 1, wherein the connecting portion includes:
a first wide-width portion that is connected to the first fixing portion;
a second wide-width portion that is connected to the second fixing portion; and
a narrow-width portion that is connected to the first wide-width portion and the second wide-width portion; wherein
a width of the first wide-width portion decreases from a width of the first fixing portion in a direction away from the first fixing portion;
a width of the second wide-width portion decreases from a width of the second fixing portion in a direction away from the second fixing portion;
a width of the narrow-width portion is smaller than the width of the first wide-width portion and the width of the second wide-width portion; and
the protrusion portion is positioned at least one side of an upper side and a lower side of the narrow-width portion when viewed in the one direction.

8. The vibration motor according to claim 1, wherein
the casing includes a base plate and a cover that covers the base plate from an upper side; and
the cover includes a cover protrusion portion that protrudes from an inner wall surface of the cover facing the end surface portion in the one direction to face the protrusion portion in the one direction.

9. The vibration motor according to claim 8, wherein the protrusion portion that is positioned above the connecting portion when viewed in the one direction is in contact with the cover protrusion portion.

10. The vibration motor according to claim 1, wherein
the casing includes a base plate and a cover that covers the base plate from an upper side;
the base plate includes a base plate protrusion portion protruding upward; and
the protrusion portion that is positioned below the connecting portion when viewed in the one direction is in contact with the base plate protrusion portion.

11. The vibration motor according to claim 1, wherein
the protrusion portion includes at least tungsten; and
a portion with which the protrusion portion is in contact in the casing includes stainless steel.

12. A vibration motor comprising:
a casing;
an elastic member; and
a vibration body that includes a weight and is supported by the elastic member with respect to the casing to be vibratable in one direction; wherein
the casing includes a base plate and a cover that covers the base plate from an upper side;
the weight includes a first side wall portion and a second side wall portion facing the first side wall portion in a longitudinal direction that is orthogonal to the one direction;
the elastic member includes a first fixing portion, a second fixing portion, and a connecting portion connecting the first fixing portion and the second fixing portion to each other;
the first fixing portion is fixed to the first side wall portion;
the second fixing portion is fixed to an inner wall surface facing the second side wall portion in the longitudinal direction in the casing;
the connecting portion faces an end surface portion of the weight in the one direction on one side in the one direction;
the cover includes a cover protrusion portion that protrudes from an inner wall surface of the cover facing the end surface portion in the one direction;
the cover protrusion portion is positioned at least one of an upper side and a lower side of the connecting portion when viewed in the one direction; and
the weight is in contact with the cover protrusion portion when the weight is displaced to a specific position.

13. The vibration motor according to claim 12, wherein the cover protrusion portion is positioned at least on an upper side of the connecting portion when viewed in the one direction.

14. The vibration motor according to claim 12, wherein the cover protrusion portion is a single monolithic member integrated with a portion other than the cover protrusion portion in the cover.

15. The vibration motor according to claim 12, wherein the cover includes a cover body portion and the cover protrusion portion as a separate member from the cover body portion.

16. The vibration motor according to claim 12, wherein the cover protrusion portion has a length in the longitudinal direction is longer than a length in a vertical direction when viewed in the one direction.

17. A tactile device comprising:
the vibration motor according to claim 1.

18. A tactile device comprising:
the vibration motor according to claim 12.
